(19) United States
(12) Patent Application Publication
(10) Pub. No.: US 2009/0249676 A1
(43) Pub. Date: Oct. 8, 2009

(54) Rain Activated Mineral Filtration Bag and Method

(76) Inventors: Donald D. Davis, Tifton, GA (US); Kelli F. Davis, Tifton, GA (US)

Correspondence Address: BERENATO, WHITE & STAVISH, LLC, 6550 ROCK SPRING DRIVE, SUITE 240, BETHESDA, MD, 20817, US

(21) Appl. No.: 12/399,961

(22) Filed: Mar. 8, 2009

Related U.S. Application Data
(60) Provisional application No. 61/041,709, filed on Apr. 2, 2008.

(51) Int. Cl. A01M 31/00

(52) U.S. Cl. 43/1; 222/189.06; 222/630

(57) ABSTRACT

The mineral and salts dispensing system is a filtration bag designed out of high strength woven geotextile fabric that is intended to filter fresh minerals/salt to the ground for deer, elk, or other animal consumption. The bag's functionality should last 2-3 years with normal use as it is UV stabilized to resist biodegrading; it is refillable with ease of installation and a cost-effective customizable solution for hunters.

### BACKGROUND OF THE INVENTION

1. Field of the Invention

The invention relates generally to a rain activated mineral filtration bag. Specifically, the invention relates to a method and apparatus for luring game, i.e., deer, elk, where a mesh containment apparatus is suspended above a likely game gathering area. Minerals and other solubles inserted into the containment apparatus are rain activated and distributed on the ground beneath the suspended containment apparatus and lure the game.

2. Background

Tracking and luring game is one of the ancient “arts” of hunting. First: locate a trail, usually leading to and from water; next, find an area that provides a clean clear opportunity at the game; third, spread lure usually in the form of female scent, urine, food, etc. Find a stable, hopefully comfortable perch, and wait. The drawback is the transient effect of the effort. It lasts only so long and is not durable enough, over time, to create habits on the part of the game, and does not automatically replenish, except for some rather complex luring systems that themselves require maintenance, batteries, etc. And, by the time any lure effect has taken hold, the hunter is long gone owing to boredom, cold, hunger, locked joints, nightfall, etc.

### SUMMARY OF THE INVENTION

The present invention advantageously fills the aforementioned deficiencies by providing a system for sporadic but continuing lure provision in remote areas with little or no involvement by the hunter post installation.

The 3D Buck-Bag system includes a bag made of relatively high strength woven UV stable geotextile mesh fabric. The bag is opened on one end to allow the filling function. The bottom seam is securely closed to prevent product from escaping in bulk. The bag has 2 side panels that have been heat sealed and/or sewn approximately ¾ to 1″ in width, which allows for additional support and longevity of the products in-use life span. The bag is preferably constructed with grommeted holes to allow for both draw string closure and for ease of hanging. The bag can be printed with logos and labeled or tagged by the user as necessary for identification.

Grommets are optional as they could be replaced by a draw cord alone. The preferred fabric can be described as a high strength woven monofilament geotextile (nylon, polypropylene, polyethylene, etc.), but could be replaced with another mesh fabric, screening, or other product such as a specially configured bucket or other hard sided container (i.e., closed top w/holes and with a hole in the bottom), so long as the construct allows it to be suspended, not tipped, so as to enable rain activated filtering minerals to fall to the ground with each rain shower or access to water source.

The 3D Buck-Bag system is designed to be sold either empty or pre-filled with selected supplements suited to the season, animals being pursued/attracted or distinct objective of the party using the lure. If they want to replenish, the question is with what (buck or other game) and how often (in what season, etc.)? If they want a pre-filled bag, what are they attracting and for what length of time do they want effectiveness. Different game will be drawn to differing combinations at differing times. In addition, the sizing of the mesh may be matched to the likely contents used to replenish. Large sized hardy minerals would best combine with a relatively larger mesh, whereas finer, smaller grained minerals and filler would combine with a finer mesh. Regardless, however, the concept for each version remains the same however; to wit: rain/water activated lure distribution from a suspended mount.

The 3D Buck-Bag is truly unlike any other product on the market today used in the sportsman arena. Its construction is designed to be long-lasting in rugged outdoor conditions. The system is versatile as it allows the purchaser to refill the product themselves with their “choice” of product, and combinations of product. It is easily comprehended that certain hunters will “swear-by” certain combinations and mixtures of minerals and lure, and shares such secrets only grudgingly. Further, owing to its sturdy construction, the same bag can be recycled for continued use year after year. The system is simple and cost effective and requires nothing other than a water source or rain shower to activate it once filled. They are lightweight, not cumbersome, easy to install and filled, even in the largest sizes, should not weigh more than 20 lbs. Once hoisted aloft and installed, they can be retrieved and moved easily which allows complete versatility for the installer.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a flat, unfilled bag

FIG. 2 is a view of the filling process

FIGS. 3 and 4 show the sealing process

FIG. 5 shows the top of the bag upon completion of the sealing process

FIG. 6 shows the bag hung in-situ

FIG. 7 shows the activation process

### DETAILED DESCRIPTION OF THE INVENTION

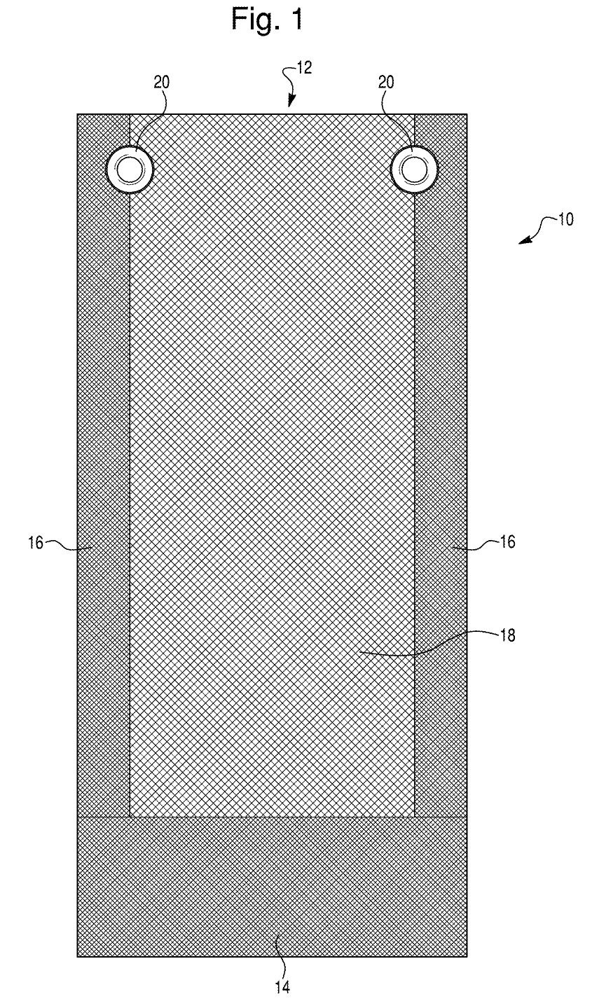

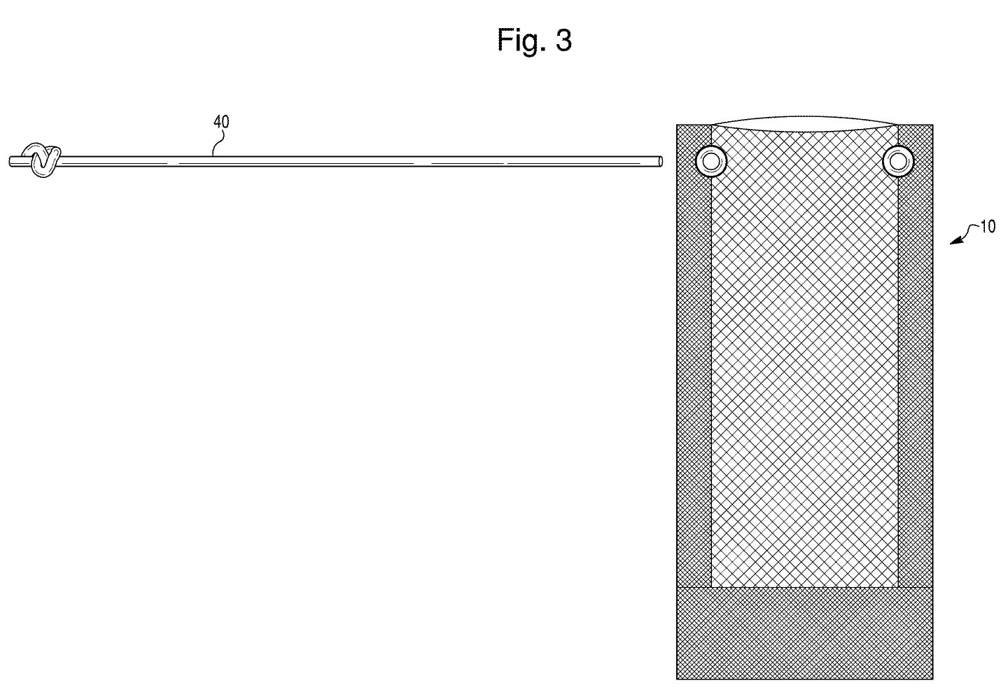

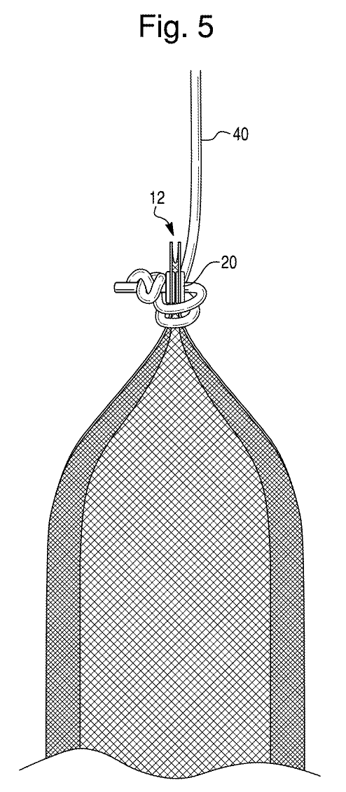

With reference to the drawing FIGS. 1-7: The present invention is directed to a 3D Buck-Bag 10—a rain activated mineral filtration bag 10. Reinforced sides 16 and bottom 14 of the 3D Buck-Bag 10 are necessary in its design and adds longevity to the product if it comes in physical contact with the animals' mouths, horns or claws. High UV stabilization is necessary to continue the long-lasting durability of the hanging 3D Buck-Bag when direct sunlight is present. Woven monofilament 18 designed for high water flow areas allows the safe filtration of minerals 30, nutrients, supplements or salt to be distributed through the openings of the woven fabric, thus keeping the balance of the filler enclosed at the same time allowing a portion of product to filter through the openings of the weave of the fabric.

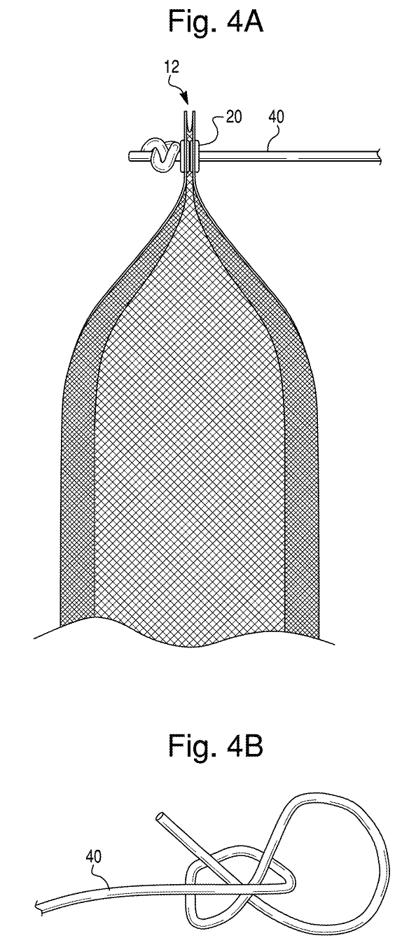

The bag 10 has heat sealed sides 16 and a heat sealed bottom 14. The sealed sides and bottom can electively be reinforced, i.e., double sewn, to account for heavier versions of the bag and lure system. The mouth 12 is open and is adapted to accept minerals and other soluble lure materials from a supply 30. The mouth 12 is held in a closed position by a rope or tether 40 that is drawn through grommets 10 placed around the mouth 12. Alternatively the rope or tether 40 can be tied lariat style (FIG. 4(b)) around the bag mouth 12 to both keep the bag 10 in a closed position and provide for its suspension from an overhanging support. The bag could be closed also by a simple plastic pull-tie and suspended from a grommet using an S-hook or length of wire, etc. The completed, empty, bag is preferably about 36 inches in length, 8½ inches wide and weighs on the order of 2-3 oz. A bag using this construction and size can hold approximately 20 lbs of granular minerals and can be printed on the outside with various patterns and designs including logos, guide information, etc. The color can vary depending on application, but colors that do not cause alarm in the intended targeted animal, i.e., deer and elk, are preferred.

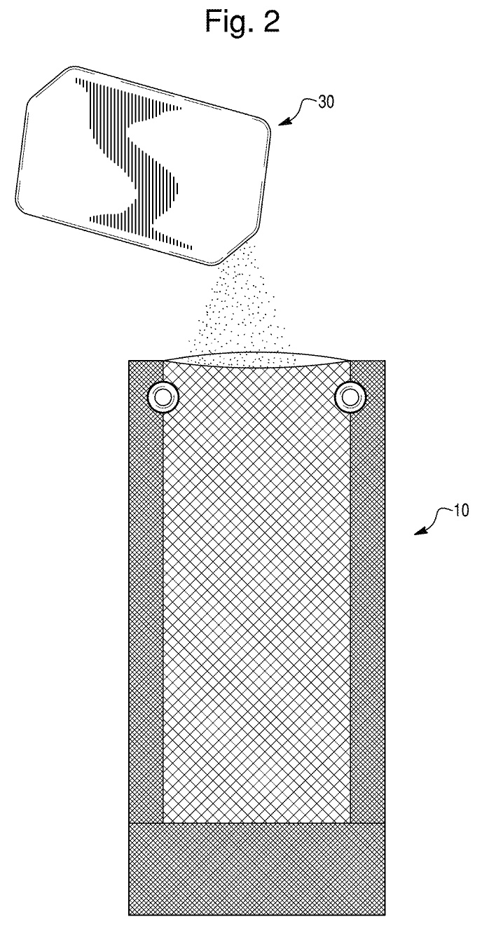

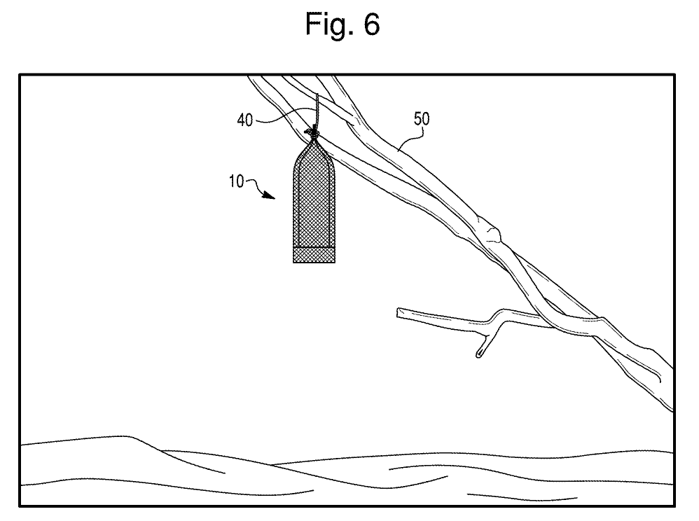

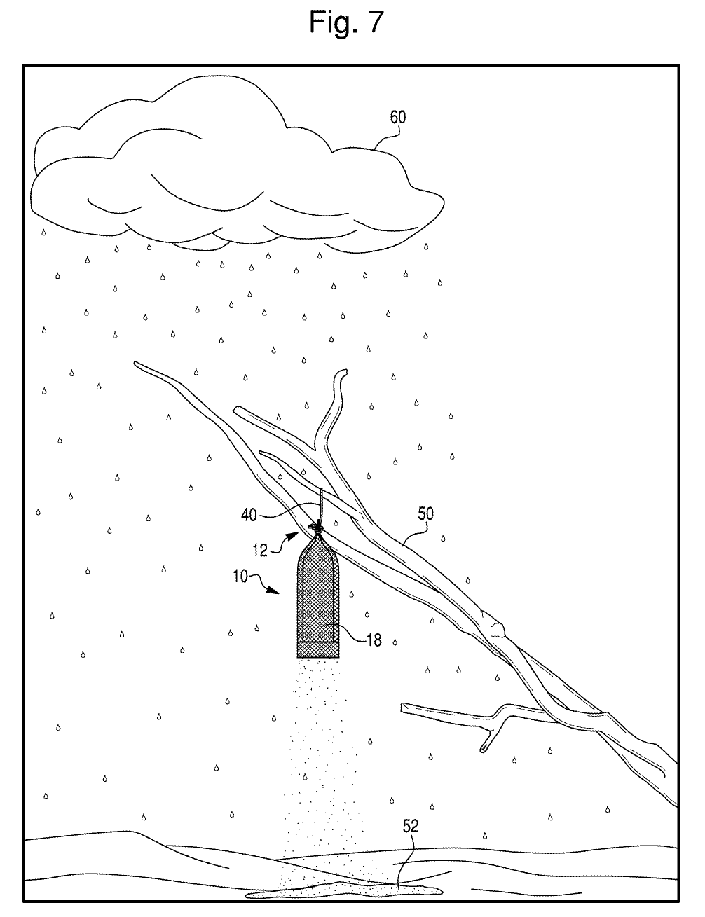

In use, the bag 10 is filled (FIG. 2), drawn closed using the rope 40, and suspended in a tree 50 (FIG. 6 and 7) or other suspended mount, i.e., pole or post. Prior to initial hanging, the bag 10 and its contents may be sprayed or dipped in water to initiate the mineral dispersion through the open weave 18 onto the ground 52 below. Thereafter, passing weather 60 re-activates the dispersion process whenever it occurs. As such, the system can create patterns of regular dispersion dependent on weather and mesh with habits of game movement that are responsive to weather. A hunter could monitor this activity and associate good and bad times to proceed to the area for hunting and/or observation. It is a lure system/process that can be used to great effect over time and can be retrieved, re-supplied, and re-hung elsewhere. Versions of the bag can be bought empty and re-filled, or provided in bio-degradable (smaller) hang and forget versions. The concept of use is the same.

The 3D Buck-Bag is designed to provide a fresh source of animal consumption minerals/salt effluent or other supplement onto the ground beneath each time the bag comes in contact with rain or another water source. It is made from a high strength monofilament fabric that is UV stabilized to resist biodegrading which allows for the approximate 2-3 year lifespan. The product is refillable, therefore it does not require replacement each time the bag is empty. It also allows minerals to last much longer than the traditional mineral block on the ground as it is activated by rain or water sources.

The materials used in the construction of the 3D Buck-Bag are important; they are selected for relatively high water flow, holding back silt, but still allowing the water to flow freely. The same principal is in operation: holding back the minerals, nutrients, salt or supplements while allowing a minimal amount of product to be released fresh each time it comes in contact with rain or water source. Non-woven fabrics are not necessarily ideal in this capacity due to much lower filtration qualities and have a much lower apparent opening size (AOS). The high strength woven geo textile fabric used in this invention has been photographed with deer and elk sucking on the bag with no destruction of the bag evident thereafter. Burlap or jute products would likely biodegrade very quickly in comparison; in addition, the effect to the animals' digestive system, i.e., chewing, sniffing, licking, in combination with degrading materials may be less than ideal. Other smaller rodent type animals may also easily rip and degrade jute or burlap. A bucket with holes would work, but be relatively undesirable due to the animals' inability to suck on the bag and it would make the product much heavier and unstable while hanging. Screen mesh would be less than ideal due to rust and tearing, which could harm the animals.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims It is indeed intended that the scope of the invention should be determined by proper interpretation and construction of the appended claims and their legal equivalents, as understood by those of skill in the art relying upon the disclosure in this specification and the attached drawings.

1. A mineral laden effluent distribution kit, comprising
a container including holes therein for maintaining water soluble minerals therein, said holes being sized so as to retain said water soluble minerals within said container when water is passed through said minerals and exits said container through said holes,
a hanging element connected to said container for suspending said container from a support,
a supply of water soluble minerals for a insertion into said container, wherein, when said minerals are inserted into said container, and said container, in a suspended position, is exposed to showered water thereon, a pool of mineral laden effluent is created on a ground surface beneath said suspended container.

2. A kit as in claim 1, wherein
said container comprises a woven fabric bag, including an open mouth at an upper end thereof along with two sealed sides connected to a sealed bottom seam, and said hanging element is a drawstring that both closes said mouth of said bag and secures said mouth in a closed position.

3. A kit as in claim 2, wherein
said bag further includes a grommets for guiding and retaining said drawstring around said bag mouth.

4. A kit as in claim 2, wherein:
said woven fabric bag comprises a UV resistant woven mono-filament non-bio-degradable material that is reinforced and heat sealed along said sides and bottom.

5. A method of luring game, comprising the steps of:
inserting a supply of water soluble minerals into a container having holes therein, said holes sized so as to retain said minerals, but also to allow water to pass through said contained minerals and dissolve said minerals and pass out of said container through said holes;
suspending said container over a pre-selected site out-of-doors;
exposing said suspended mineral containing container to passing rain showers, and, attracting game to said pre-selected site by creating a pool of mineral laden effluent on a ground surface beneath said suspended container.

6. A method as in claim 5, wherein:
said minerals comprise salts and mineral especially intended for animal consumption.
